(19) United States
(12) Patent Application Publication
(10) Pub. No.: US 2026/0147902 A1
(43) Pub. Date: May 28, 2026

(54) SYSTEM-WIDE FILE PROTECTION THAT PERSISTS ACROSS DEVICES

(71) Applicant: Microsoft Technology Licensing, LLC, Redmond, WA (US)

(72) Inventors: Aashish RAMDAS, Seattle, WA (US); Xi CHEN, Redmond, WA (US); Zheng LIN, Issaquah, WA (US); Henry Nexon FERGUSON, Redmond, WA (US); Tewang CHEN, Redmond, WA (US)

(21) Appl. No.: 18/960,973

(22) Filed: Nov. 26, 2024

(51) Int. Cl. G06F 21/60; G06F 21/62

(52) U.S. Cl. CPC G06F 21/602; G06F 21/604; G06F 21/6209

(57) ABSTRACT

This disclosure principally describes a framework for providing endpoint encryption-based file protection at the system-wide level on client devices. For instance, this disclosure describes a file protection system that utilizes a holistic, system-wide security approach to provide trusted container solutions for protected files accessed on a client device. For example, the file protection system creates and binds security information metadata to protected file content at an endpoint device, which helps enforce the access rights and permissions of a file at a system-wide level. In addition, the security information metadata remains bound to the file even if the protected content is modified. Furthermore, if the file is shared with another client device, the security information metadata within the file enables the file protection system to maintain the initially set protections and access rights on the other client devices.

### CROSS-REFERENCE TO RELATED APPLICATIONS

N/A

### BACKGROUND

Recent advancements in hardware and software have significantly enhanced data security, particularly in file protection. Many enterprise systems now combine encryption with access permissions and granular usage rights, enforcing restrictions on actions like copying, printing, saving, and sharing files. Despite these improvements, substantial technical challenges remain, especially in ensuring consistent file protection across diverse applications. For example, some systems require specialized applications with limited functionality to access protected content without compromising security. Additionally, many solutions demand significant computational resources to access protected files, whether on the same device or when shared across different devices. Furthermore, organizations often struggle to balance robust security measures with user accessibility. These ongoing challenges underscore the complexities that current approaches face in delivering effective file security and protection.

### BRIEF DESCRIPTION OF THE DRAWINGS

The following detailed description provides example implementations accompanied by drawings. Each of the figures listed below includes illustrated example implementations corresponding to one or more implementations discussed in this disclosure.

FIG. 1 illustrates an overview of the file protection system that generates and enforces file protections within a client device and across client devices.

FIG. 2 illustrates a computing environment in which the file protection system (e.g., a system-wide file protection system) is implemented.

FIG. 3 illustrates an example block diagram of generating a protected unencrypted file or a protected encrypted file with security information metadata on a client device.

FIG. 4 illustrates an example block diagram of generating a protected unencrypted file or a protected encrypted file with security information metadata from encrypted content.

FIG. 5 illustrates an example block diagram of allowing an application on a client device limited access to a protected encrypted file or a protected unencrypted file.

FIG. 6 illustrates an example block diagram of using security information metadata to access the content of a protected encrypted file and re-protecting the content in a modified protected encrypted file that retains the same access rights and permissions.

FIG. 7 illustrates an example sequence diagram of providing a protected encrypted file across client devices while maintaining the originally implemented access rights and permissions.

FIGS. 8-9 each illustrate an example series of acts in a computer-implemented method for providing system-wide endpoint file protection on a computing device.

FIG. 10 illustrates example components included within a computer system used to implement the file protection system.

### DETAILED DESCRIPTION

This disclosure principally describes an example framework for providing endpoint encryption-based file protection at the system-wide level on client devices. For instance, this disclosure describes a file protection system that utilizes a holistic, system-wide security approach to provide trusted container solutions for protected files accessed on a client device. For example, the file protection system creates and binds security information metadata to protected file content at an endpoint device, which helps enforce the access rights and permissions of a file at a system-wide level. In addition, the security information metadata remains bound to the file even if the protected content is modified. Furthermore, if the file is shared with another client device, the security information metadata within the file enables the file protection system to maintain the initially set protections and access rights on the other client devices.

As mentioned, this disclosure provides an example framework for providing endpoint encryption-based file protection at the system-wide level on client devices. While specific examples, implementations, and embodiments are provided, the framework for providing endpoint encryption-based file protection may be expanded to additional methods and approaches. Additionally, while a file protection system is described, in various instances, a content protection system may be utilized to provide endpoint encryption-based content protection at the system-wide level on client devices. In these instances, content may include a content package, a packet of content, a block of content, or a portion of database content.

Implementations of the present disclosure provide benefits and solve problems in the art with systems, computer-readable media, and computer-implemented methods by using a file protection system that provides and enforces system-wide protection of files across an endpoint client device as well as other endpoint client devices. As described below, the file protection system utilizes a system-wide security approach and security information metadata to efficiently enforce consistent file protections, regardless of the device or application requesting access to the file.

To briefly demonstrate how the file protection system provides system-wide endpoint file (or content package) protection on a computing device, in various implementations, the file protection system identifies file content to be protected on a client device. The content may be newly generated or obtained from a previously encrypted file. The file protection system generates security information metadata for the content, which indicates access rights and permissions (e.g., data loss prevention data) for the content. Additionally, the file protection system binds the security information metadata to the content to generate a protected file on the client device. If the content is protected, the file protection system generates a protected encrypted file. Otherwise, the file protection system generates a protected unencrypted file (e.g., a file-based trust container).

Furthermore, in response to receiving a file access request on the client device for the protected file, the file protection system determines whether to provide access to the content based on the security information metadata. For example, the file protection system compares the file access request to the security information metadata and determines to grant limited access to the protected content. In response to the file access request, the file protection system authorizes limited access to the content.

In some implementations, the file protection system allows various applications to access the protected file content. For example, each time an application on a client device requests access to the protected file, the file protection system utilizes the security information metadata to determine what type of access to grant the application. This access enforcement still applies even if the content is unencrypted on a client device. Furthermore, when the client device sends the protected file to another client device, the file protection system uses the security information metadata to re-encrypt the content (even if modified) with the same access rights and permissions as before, thereby preserving the original security intent of the file even when it is shared with another endpoint.

As described in this disclosure, the file protection system delivers several significant technical benefits in terms of improved security, efficiency, accuracy, and flexibility compared to current file protection approaches. Furthermore, the file protection system provides several practical applications that address problems related to improving access to protected files on a client device while preserving the originally implemented access rights and permissions for protected files shared with other endpoint client devices.

Specifically, the file protection system improves security accuracy over current approaches. As mentioned above, the file protection system binds security information metadata to content to generate a protected file. The security information metadata includes access rights and permissions for the content. By binding security information metadata to the content (either in a protected or unprotected form), the file protection system provides improved computing efficiency and accuracy by facilitating access to the content by applications on a client device (e.g., in response to a file access request) according to the specified access rights and permissions included in the security information metadata rather than removing protections to the content to obtain access by the applications. In addition, the security information metadata improves computing efficiency and accuracy by enabling content to be modified while maintaining the original security access rights and permissions across content versions on an endpoint device. Indeed, improved security on a client device allows a client device to operate more efficiently and accurately.

Furthermore, the security information metadata allows the corresponding content to be accurately re-encrypted with the security posture and shared across endpoint client devices. For example, the file protection system can decrypt and subsequently accurately re-encrypt content using the security information metadata to the same file protections. Indeed, the file protection system provides improved security by using the security information metadata to allow the file to be shared across multiple client devices while restricting access or providing limited access to users authorized by the system or the user who provided the original set of access rights and permissions included in the security information metadata.

As mentioned, the file protection system provides improved efficiency for a client device compared to existing approaches. For example, because the file protection system is implemented at the system level, some or all files at the endpoint can be individually protected using the same approach. This provides improved efficiency and reduces operational overhead compared to current approaches that utilize application-level file protection, which necessitates different operations and rights enforcement by each application. Indeed, changes to applications are necessary because the file protection system provides file protection at the system level.

As another example, in some instances, when obtaining unencrypted content on a client device, the file protection system generates a protected unencrypted file, which includes the unencrypted content and corresponding security information metadata. As long as the protected unencrypted file remains on the client device (or within a defined protected environment or portion of the client device), the content stays unencrypted. Applications wanting to access the content need only be granted access based on the access rights and permissions included in the security information metadata. However, the client device does not need to perform the computationally resource-intensive process of decrypting and re-encrypting the content each time a file access request is identified.

As mentioned above, the file protection system provides improved flexibility over current approaches. For example, the file protection system operates at the system level on a client device and works with various applications on the client device. Indeed, the file protection system is application-agnostic, with applications not needing any type of reconfiguration to be compatible with the file protection system. Similarly, the file protection system is both operating system-agnostic and platform-agnostic. For instance, the file protection system functions on computers with different operating systems and device types. The file protection system generates protected files that include security information metadata bound to corresponding content, providing centrally configured security settings applied to the content regardless of whether the content is encrypted or unencrypted, and regardless of device location.

As illustrated in the foregoing discussion, this disclosure utilizes a variety of terms to describe the features and advantages of one or more implementations described. For example, the term “endpoint device” (or “endpoint”) refers to a computing device that connects to a network and serves as a point of access for users. Endpoint devices can include computers, smartphones, tablets, printers, and Internet of Things (IoT) devices. Endpoint devices allow access to protected data and may, therefore, serve as potential entry points for security threats. Protecting endpoint devices against unauthorized access is essential to safeguarding sensitive data.

In this document, the term “operating system” (or OS) refers to a software layer on a client device that manages computer hardware and software resources. An operating system typically provides a user interface and facilitates the execution of applications, acting as an intermediary between users and the computer hardware, thus enabling users to perform tasks such as running programs, managing files, and controlling peripheral devices.

The term “system-wide level” refers to operations, processes, and tasks that affect the entire computing environment rather than individual applications or users. For example, the file protection system performs system-wide operations that include intercepting, processing, and authorizing communication between applications and the operating system.

In many implementations, the term “application” refers to a software program designed to perform specific tasks. Applications often request access to files to view, edit, modify, create, share, or otherwise interact with their content.

As another example, the term “content” refers to data that is stored in a data format or structure. Content typically refers to the primary data stream of a file, which includes the visible data displayed to a user when the file is accessed. Content can include a variety of data types, including text, images, audio, or a combination thereof. Additionally, content may be protected by encryption and/or other security measures, as provided below.

In some instances, the term “file” may more generally represent content within a data structure, such as content package, a packet of content, a block of content, or a portion of database content. For example, in some implementations, a file represents a content package on a client device. For instance, in response to receiving a content package access request on the client device, the file protection system (or content package protection system) creates a protected unencrypted content package (or protected encrypted content package) that includes security information metadata and unencrypted content (or encrypted content).

To access a protected file, an application often sends a file access request. In this document, a “file access request” refers to a formal appeal made by an application (or user) to obtain permission to access specific files within a system. A file access request often includes the type of access needed (e.g., read, write, or execute). In addition, a file access request includes a user identifier, information about the file(s) in question, the specific permissions sought, and/or a justification for the request. The file protection system grants file access requests by providing full access, partial or limited access, or denied access.

As an example, the term “access rights and permissions” refers to the rules and settings that determine the content and resources a device, user, or system can access and the actions permitted to be performed on that content. In various implementations, access rights and permissions represent data loss prevention/protection (DLP) measures that guard against unauthorized file access. For example, access rights can define the levels of access a user, application, or device has to resources, such as read, write, copy, print, or execute permissions. Permissions may include specific authorizations granted to users or groups, allowing them to perform certain actions, like modifying files or accessing specific applications. A set of access rights and permissions for a file may enable a user, application, or device with limited access (e.g., less than full access or with at least one restriction regarding access to a file).

One example of access rights and permissions includes which specific users, user groups, devices, and/or device groups are granted access. Another example of access rights and permissions includes defining the scope of file extensions that are protected by the file protection system (along with file extensions excluded from this scheme). Access rights and permissions can include required protection for a protected file when it is egressed (e.g., egress boundaries), excluded file paths, and the policy enforcement status of a file on a client device.

In this document, the term “security information metadata” refers to additional data associated with a primary file stream that provides critical information about the file's security attributes, including encryption labels and access controls. In various instances, security information metadata is stored as an alternate data stream (ADS) within a file system, allowing it to remain linked to or bound to the primary file while being separate from its main content. By embedding encryption labels and other security-related details in this manner, organizations can enhance data protection and ensure that sensitive information is properly managed and secured, even if the primary file is accessed or modified.

Security information metadata includes the access rights and permissions of content within a file. Accordingly, when a file includes security information metadata, it is referred to as a “protected file” (or a protected content package). A protected file includes both a protected encrypted file and a protected unencrypted file. A “protected encrypted file” (or a protected encrypted content package) refers to a file in which the content is encrypted based on the security conditions included in the corresponding security information metadata. A “protected unencrypted file” (or an unprotected encrypted content package) refers to a file in which the content is unencrypted. However, in many instances, access to the content by applications is limited or restricted by the access rights and permissions indicated in the corresponding security information metadata. For instance, when an application requests access to a protected unencrypted file, the file protection system intercepts the request and applies the access rights and permissions to grant full, partial, limited, or denied access to the file's contents.

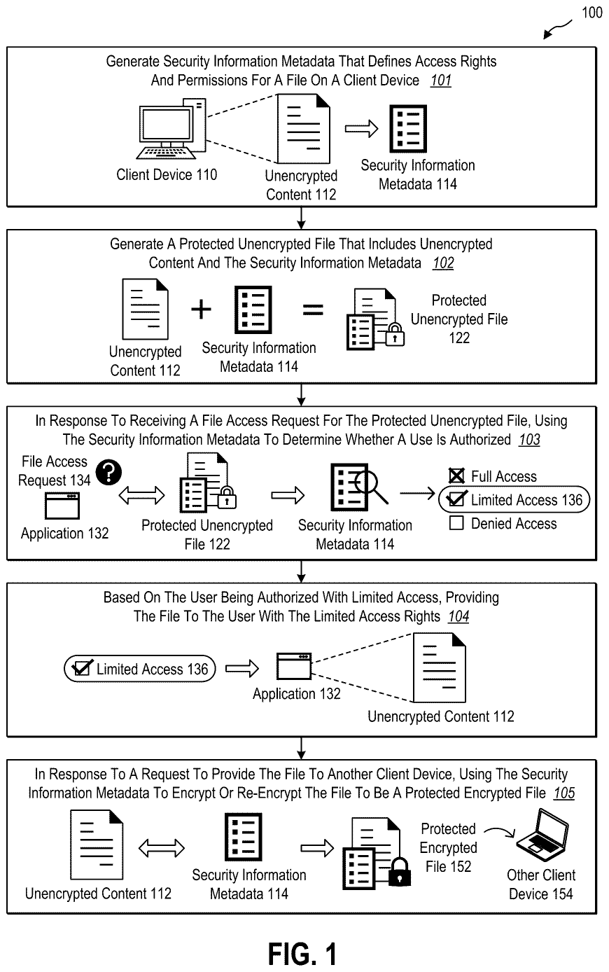

Implementation examples and details of the file protection system (e.g., a system-wide endpoint file protection system) are discussed in connection with the accompanying figures, which are described next. For example, FIG. 1 illustrates an overview of the file protection system that generates and enforces file protections within a client device and across client devices according to some implementations. In particular, FIG. 1 includes a series of acts 100 for providing improved file protection to files on a client device and shared across client devices, performed by the file protection system.

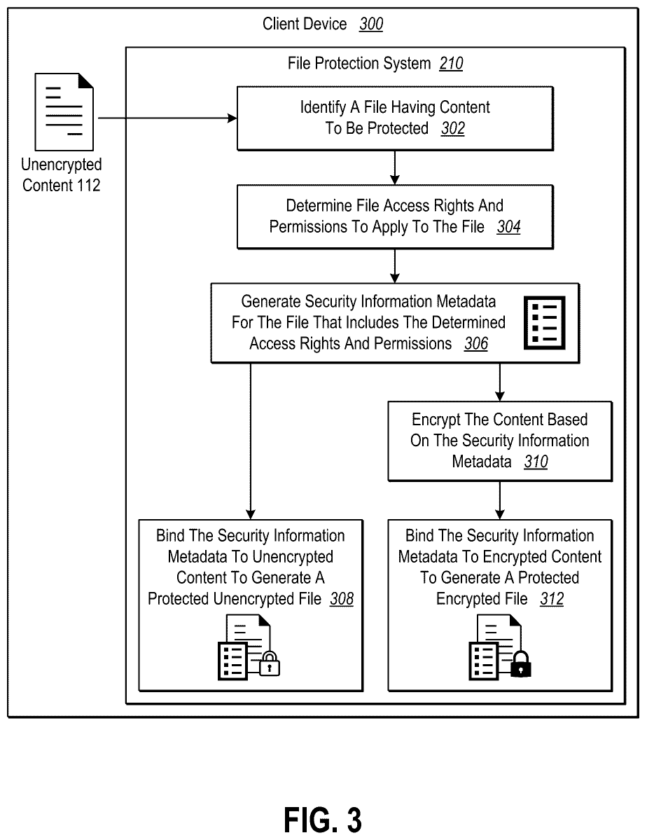

As shown, the series of acts 100 includes act 101 of generating security information metadata that defines access rights and permissions for a file on a client device. For example, the file protection system identifies unencrypted content 112 on a client device 110. The unencrypted content 112 may be content generated on the client device 110 or received at the client device 110 (either as an unencrypted file or as an encrypted file that becomes decrypted). The file protection system then generates security information metadata 114 for the unencrypted content 112. As further described below, the security information metadata 114 includes access rights and permissions for accessing the unencrypted content 112 (or a decrypted version of the content). Additional details about generating security information metadata for content are provided further below in connection with FIG. 3.

Act 102 includes generating a protected encrypted file that includes unencrypted content and the security information metadata. For instance, the file protection system binds the security information metadata 114 to unencrypted content 112 to create a protected unencrypted file 122 on the client device 110. In some instances, the file protection system binds the security information metadata 114 to encrypted content to generate a protected encrypted file. Indeed, the file protection system generates a protected file by binding the security information metadata 114 to content that is either protected or unprotected. Additional details about binding security information metadata to corresponding content to generate protected files are provided further below in connection with FIG. 3.

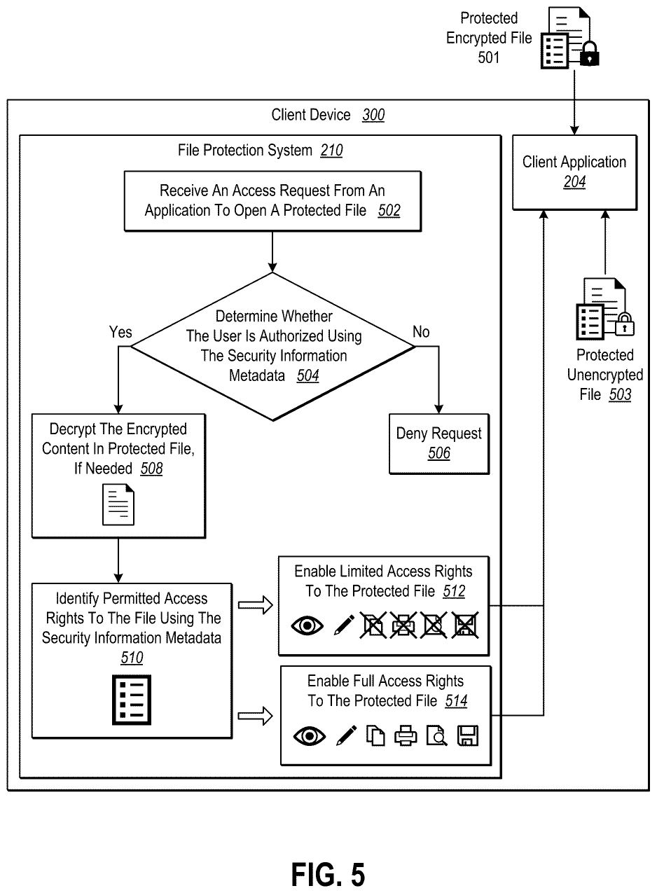

Act 103 includes using the security information metadata to determine whether a user is authorized in response to receiving a file access request for the protected unencrypted file. For instance, when an application 132 on the client device 110 provides a file access request 134 to access the protected unencrypted file 122, the file protection system, which is implemented at a system-wide level, identifies the use of the security information metadata 114 to determine access permissions. As further described below, the file protection system determines whether to grant full access, limited access 136, or denied access in response to the file access request 134. Additional details about determining access rights for content using corresponding security information metadata are provided further below in connection with FIG. 5.

Act 104 includes providing the file to the user with limited access rights based on the user being authorized with limited access. For instance, the file protection system responds to the file access request 134 by indicating that the unencrypted content 112 may be accessed according to the limited access 136. For example, the limited access 136 may allow authorized users to open the content in the protected unencrypted file. In some instances, the limited access 136 indicates certain rights (e.g., read and execute) while denying other rights (e.g., deleting or editing). Additional details about providing access rights to client applications on a client device according to security information metadata are provided further below in connection with FIG. 5.

Act 105 includes using the security information metadata to encrypt or re-encrypt the file to create a protected encrypted file in response to a request to provide the file to another client device. In various implementations, the file protection system identifies a request to provide the protected unencrypted file to another client device. In these instances, the file protection system converts the unencrypted content 112 and the security information metadata 114 in the protected unencrypted file to a protected encrypted file 152, along with the security information metadata 114.

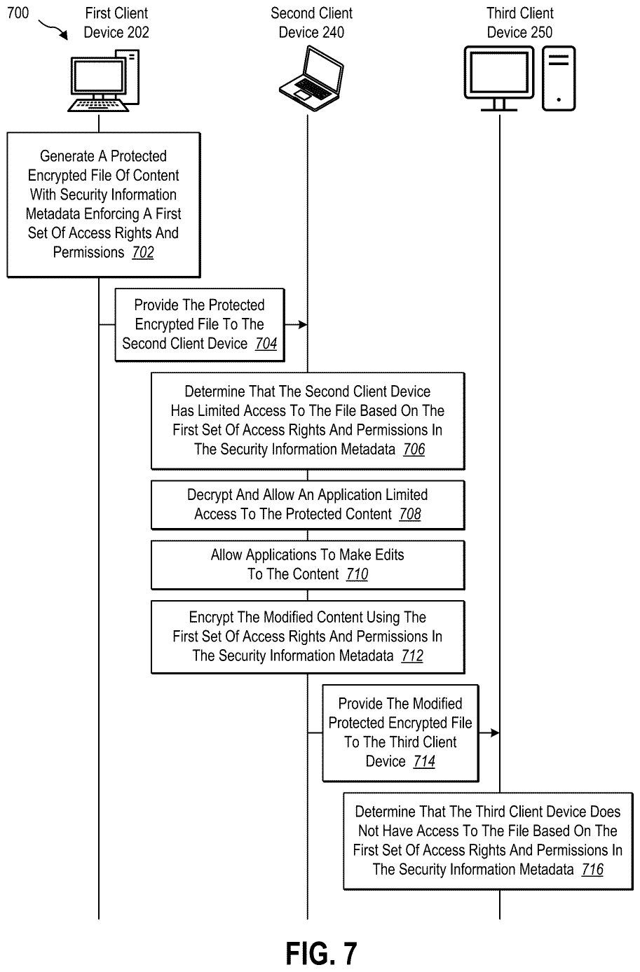

The protected encrypted file 152 can then be provided to another client device 154. A version of the file protection system on the other client device 154 uses the security information metadata 114. For example, the file protection system on the other client device 154 can use the security information metadata 114 to decrypt the protected encrypted file 152, generate a protected unencrypted file on the other client device 154, and/or grant (or deny) file access requests from applications on the other client device 154 using the security information metadata 114 bound to the file content. Additional details about using the security information metadata to protect and grant access rights across client devices are provided further below in connection with FIG. 7.

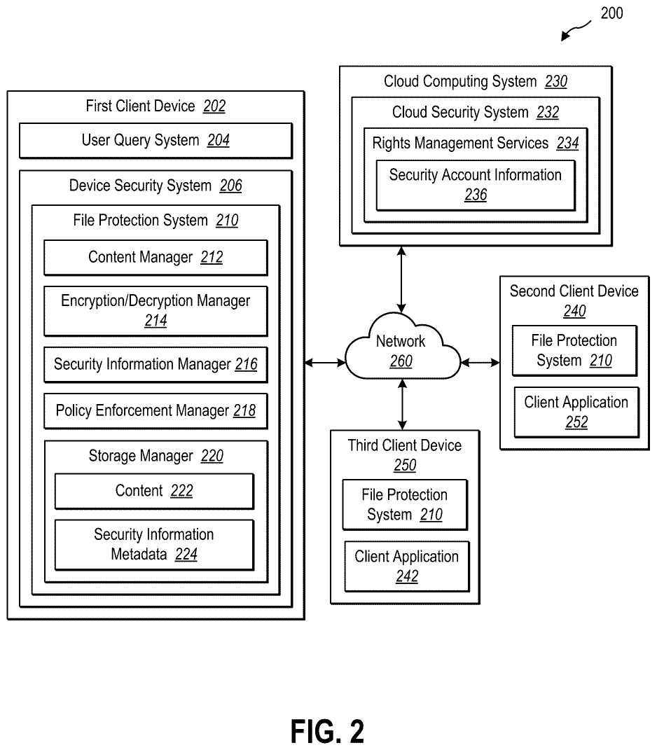

With a general overview in place, additional details are provided regarding the components, features, and elements of the file protection system. To illustrate, FIG. 2 shows an example computing environment in which the file protection system is implemented according to some implementations. In particular, FIG. 2 illustrates an example of a computing environment 200 with various computing devices, including client devices (e.g., a first client device 202, a second client device 240, and a third client device 250) and a cloud computing system 230. The computing devices in the computing environment 200 are connected via a network 260.

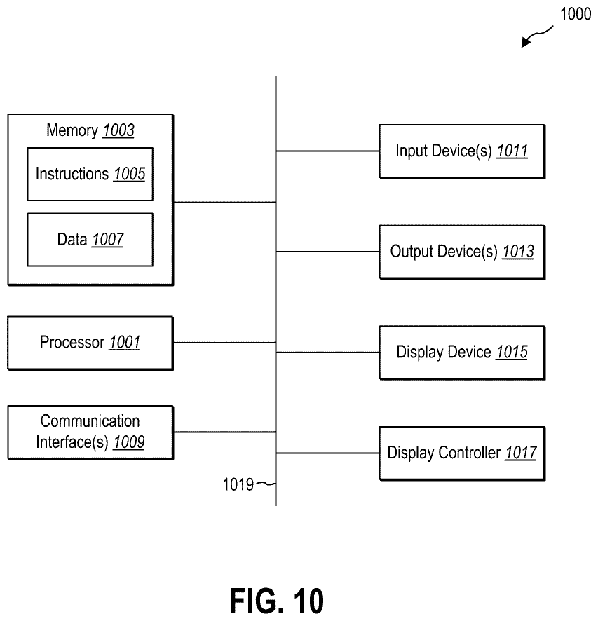

While FIG. 2 shows example arrangements and configurations of client devices with file protection systems within the computing environment 200, other arrangements and configurations are possible. Additionally, further details regarding computing devices are provided below in connection with FIG. 10, which also includes more information about networks, such as the network 260 shown.

As shown, the computing environment 200 includes a first client device 202. As described further below, the first client device 202 may correspond to a personal computer (PC) or another personal device, including portable devices that include multithreaded processing capabilities. In various implementations, the first client device 202 is associated with a user who utilizes applications on the client device to modify content in protected files.

The first client device 202 includes a client application 204. In some implementations, the client application 204 represents one or more software applications located on the first client device 202. The client application 204 may include a web browser, an office application, a file management application, a media player, or another type of content consumption or modification application. In many implementations, the client application 204 does not require any modifications or updates to access protected files with enforced access permissions and rights provided by the file protection system 210.

The first client device 202 also includes a device security system 206. In various implementations, the device security system 206 provides security features to protect the first client device 202 from various cyber threats. For example, the device security system 206 can provide real-time protection against malware, viruses, spyware, and other malicious software by continuously scanning files and applications for potential threats. Additionally, the device security system 206 facilitates the protection of files received at, stored by, and shared from the first client device 202. In many instances, the device security system 206 is a system-wide service and/or is integrated into the operating system of the first client device 202.

As shown, the device security system 206 implements a file protection system 210. In some implementations, the file protection system 210 is located separately from the device security system 206. For instance, the file protection system 210 is a standalone service on the first client device 202 that implements file protection for both the first client device 202 and other client devices. In many implementations, the file protection system 210 operates at a system-wide level to ensure accurate and efficient file protection across multiple clients.

In various implementations, including the illustrated one, the file protection system 210 includes various components and elements implemented in hardware and/or software. For example, the file protection system 210 includes a content manager 212, an encryption/decryption manager 214, a security information manager 216, a policy enforcement manager 218, and a storage manager 220. As shown, the storage manager 220 includes content 222 and security information metadata 224, among other data used by the file protection system 210.

To elaborate, in various implementations, the content manager 212 facilitates the management of content 222 included on the first client device 202. For example, the content manager 212 facilitates receiving and sending content 222 to and from other client devices, such as the second client device 240, the third client device 250, and/or other client devices.

In various implementations, the encryption/decryption manager 214 facilitates protecting the content 222 with encryption and/or additional file protection techniques. The encryption/decryption manager 214 may perform encryption operations on content 222 based on the security information metadata 224 associated with the content. Similarly, the encryption/decryption manager 214 may carry out decryption operations based on the security information metadata 224.

As mentioned above, the file protection system 210 includes the security information manager 216, which facilitates generating, accessing, and applying security information metadata 224. In various implementations, the security information metadata 224 indicates the access rights and permissions for applications, users, and/or systems regarding the corresponding file content.

In one or more implementations, the policy enforcement manager 218 enforces security policies according to the security information metadata 224. For example, when the client application 204 provides a file access request to access content, the policy enforcement manager 218 utilizes the security information metadata to determine whether to grant the access request and what rights to permit.

As shown, the computing environment 200 includes a cloud computing system 230 having a cloud security system 232. In various implementations, the cloud security system 232 operates in conjunction with one or more file protection systems on one or more client devices. In some implementations, the cloud security system 232 provides similar functions as the device security system 206 for one or more server devices on the cloud computing system 230.

As shown, the cloud security system 232 includes a rights management service 234 that includes security account information 236. For instance, the rights management service 234 may provide cloud-based security services and/or a security-focused cloud infrastructure. In various implementations, the security account information 236 provides security details corresponding to users, applications, and/or devices. For example, the security account information 236 grants the file protection system 210 on the first client device 202 access rights, permissions, and/or security policies to enforce content within a target file. In some implementations, the security account information 236 is based on the organization and/or user attempting to impose restrictions on the content within a file.

As mentioned above, the computing environment 200 includes the second client device 240 and the third client device 250, each with a version of the file protection system 210 and respective client applications (e.g., client application 242 on the second client device 240 and client application 252 on the third client device 250). The second client device 240 and the third client device 250 may operate similarly to the first client device 202. For example, the file protection system 210 on each client device can generate security information metadata for content and use security information metadata to determine whether to grant (or deny) access rights and permissions for protected files. In particular, the file protection system on client devices can ensure that the original set of access rights and permissions is consistently enforced, even as a protected encrypted file is shared across the computing environment 200 with different client devices.

Turning to the next figures, FIGS. 3-7 illustrate example diagrams of the file protection system 210 for providing system-wide endpoint file protection on a computing device and across client devices. To begin, FIG. 3 provides additional details about generating security information metadata and binding it to corresponding content to create protected files. In particular, FIG. 3 illustrates an example block diagram of generating a protected unencrypted file or a protected encrypted file with security information metadata on a client device according to some implementations.

As shown, FIG. 3 includes a client device 300 that may represent one of the client devices described above (e.g., the first client device 202 or the second client device 240). The client device 300 includes unencrypted content 112, as introduced above. For example, the unencrypted content 112 is a file generated by an application on the client device 300. In some instances, the unencrypted content 112 is received or downloaded to the client device 300. In its unencrypted form, the unencrypted content 112 is freely accessible by applications and users.

In addition, the client device 300 includes an instance of the file protection system 210. For purposes of explanation, the file protection system 210 includes a series of actions that correspond to generating and binding of security information metadata to content to generate a protected file. In some instances, protected files can be selectively enabled on a per-file basis. In these instances, selected files become protected files monitored and policy-enforced by the file protection system 210.

To demonstrate, the file protection system 210 performs a first act 302 of identifying a file having content to be protected. For instance, the file protection system 210, which operates at a system level, receives a request to protect the unencrypted content 112 as a protected file. In some implementations, the request is made to a device security system (also operating at a system-wide level) and handled by the file protection system 210. In various implementations, the request is made to the operating system of the client device 300 but intercepted by the file protection system 210, which addresses system-wide file access requests.

FIG. 3 shows the file protection system 210 performing act 304 of determining file access rights and permissions to apply to the file. For example, the file protection system 210 determines how to protect the unencrypted content and what access rights and/or permissions are needed for accessing the content once it is protected. In one or more implementations, the unencrypted content 112 includes metadata that provides security information for protecting and safeguarding the content.

In some implementations, the file protection system 210 determines access rights based on security policies associated with the unencrypted content 112. For example, if the unencrypted content 112 is linked with an entity or organization, the file protection system 210 may identify access rights and permissions established by the organization. The organization may require different levels or sets of access rights based on various factors, such as projects, personnel, and/or devices associated with the unencrypted content 112.

In various implementations, the file protection system 210 determines access rights and permissions based on user identifiers. For example, a user identifier is associated with user account information that indicates the security requirements for the user and other users who may interact with the user. In various implementations, the file protection system 210 determines access rights and permissions for the unencrypted content 112 based on a combination of the factors mentioned above.

In one or more implementations, the file protection system 210 communicates with a remote system or device to obtain access rights and permissions for the unencrypted content 112. For example, the file protection system 210 communicates with a rights management service on a remote device to identify access rights and permissions for the unencrypted content 112 based on one or more factors, such as user identifier, device identifier, entity identifier, or content properties.

As shown, the file protection system 210 performs act 306 of generating security information metadata for the file that includes the determined access rights and permissions. For example, in various implementations, the file protection system 210 generates security protection labels that include information about the classification and protection settings of the unencrypted content 112. In various implementations, a security protection label is stored as security information metadata. In some implementations, the security information metadata also includes encryption and decryption information and protocols for adding protections to the corresponding file.

In various implementations, the file protection system 210 provides an application programming interface (API) with a data loss prevention (DLP) service to generate the security protection labels and/or security information metadata. In various implementations, the file protection system 210 functions as, provides, and/or utilizes an information protection client to generate the security information metadata.

Once the security information metadata is generated, the file protection system 210 may bind it to the content (e.g., the unencrypted content 112). For example, the content serves as a file's primary data stream, and the file protection system 210 adds the security information metadata to the file as an alternative data stream. In various implementations, the security information metadata is added as a hidden system file portion within the file structure that also includes the content.

To illustrate, act 308 includes the file protection system 210 binding the security information metadata to unencrypted content to generate a protected unencrypted file. In various implementations, the file protection system 210 adds the security information metadata to the unencrypted content 112 to create a protected unencrypted file. Often, a protected unencrypted file remains within a protected local environment on a client device. For example, by creating a protected unencrypted file, the file protection system 210 can enforce the access rights and permissions included in the security information metadata without needing to decrypt and encrypt each time an application on the client device is granted access.

Act 310 includes the file protection system 210 encrypting the content based on the security information metadata. For example, the file protection system 210 encrypts the unencrypted content 112 using one or more encryption techniques. In some implementations, the security information metadata includes encryption protocol information. In various implementations, the security information metadata indicates the systems, applications, and/or user identifiers that have permission to access the encrypted content.

Act 312 includes the file protection system 210 binding the security information metadata to the encrypted content to generate a protected encrypted file. For instance, the file protection system 210 combines the security information metadata with an encrypted version of the content. By creating a protected encrypted file, the file protection system 210 adds additional protection to the content maintained on a client device. It also allows the content to be securely shared with other client devices and further re-shared without compromising the security of the content.

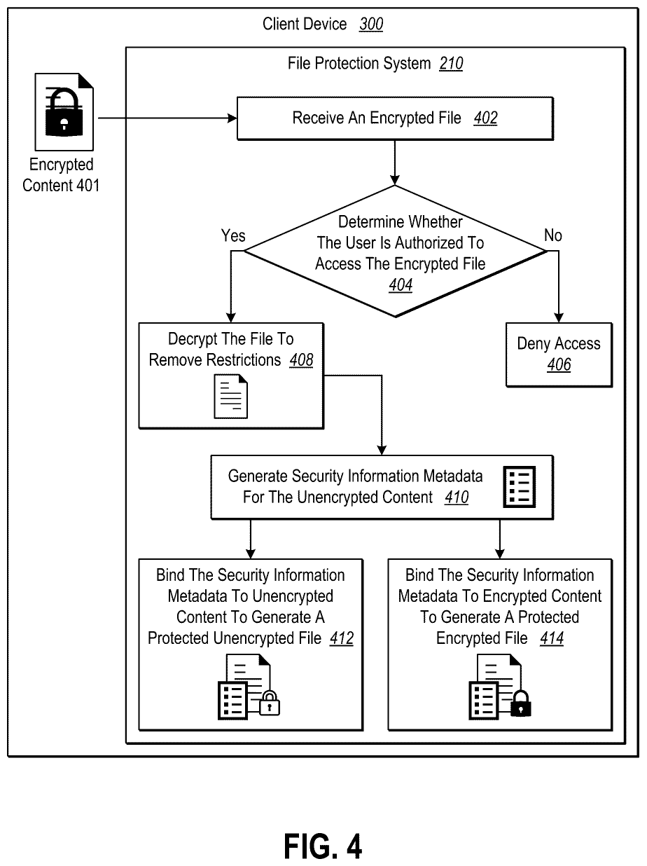

As mentioned above, FIG. 4 corresponds to generating a protected file for content. In particular, FIG. 4 illustrates an example block diagram for generating a protected encrypted file or a protected encrypted file with security information metadata from encrypted content.

Similar to FIG. 3, FIG. 4 includes the client device 300 with an instance of the file protection system 210. FIG. 4 also includes the encrypted content 401. Again, for the purpose of explanation, the file protection system 210 includes a series of actions that correspond to creating and binding of security information metadata to content to generate protected files.

To illustrate, FIG. 4 includes the file protection system 210 performing act 402 of receiving an encrypted file. For example, the client device 300 receives the encrypted content 401 from another client device or system. In response, the file protection system 210 determines whether the user is authorized to access the encrypted file, as shown in act 404.

If the user associated with the client device 300 is determined to be unauthorized to access the encrypted file, then the file protection system 210 denies access to the encrypted content 401, as shown in act 406. For example, the file protection system 210 utilizes security protection label information associated with the encrypted content 401 to determine that the user is not authorized to access the encrypted content 401.

Conversely, as shown in act 404, if the file protection system 210 determines that the user is authorized (e.g., fully authorized), then the file protection system 210 performs act 408 of decrypting the file to remove restrictions. For example, the file protection system 210 utilizes security protection label information associated with the encrypted content 401 to determine user authorization, and, once authorized, removes the file protections to obtain unencrypted content.

Act 410 includes the file protection system 210 generating security information metadata for the unencrypted content. For example, as described above, the file protection system 210 identifies access rights and permissions for the content and generates corresponding security information metadata. In various implementations, the file protection system 210 uses and/or transfers security information from the security protection label of the encrypted content 401 into the security information metadata. Unlike current systems that discard label protection information, the file protection system 210 can convert this temporary security information into persistent security information stated as security information metadata.

As shown, act 412 includes the file protection system 210 binding the security information metadata to unencrypted content to generate a protected unencrypted file. Act 414 includes the file protection system 210 binding the security information metadata to encrypted content to generate a protected encrypted file. Acts 412 and 414 correspond to acts 308, 310, and act 312, which are described above.

As mentioned above, FIG. 5 provides additional details about determining and providing access rights for content using corresponding security information metadata. In particular, FIG. 5 illustrates an example block diagram of allowing an application on a client device limited access to a protected encrypted file or a protected unencrypted file according to some implementations.

FIG. 5 includes the client device 300 introduced above, along with an instance of the file protection system 210. FIG. 5 also includes a protected file. As mentioned earlier, a protected file includes content coupled with security information metadata. To illustrate, the protected file may be a protected encrypted file 501 provided to the client device 300 or a protected unencrypted file 503 stored on the client device 300. In some implementations, the client device 300 may receive a protected unencrypted file.

The client device 300 also includes a client application 204. The client application 204 may represent one or more applications on the client device 300 that request access to the protected file. For example, the client application 204 is part of an office application suite (e.g., a word processing application, a spreadsheet application, or a presentation application). In some implementations, the client application 204 is a media application, such as an image viewer or a video player.

As shown, the file protection system 210 includes a series of acts, including act 502 of receiving an access request from an application to open a protected file (e.g., the protected encrypted file 501 or the protected unencrypted file 503).

In various implementations, the file protection system 210 receives the file access request by intercepting it. For example, the client application 204 provides a file access request to the operating system of the client device 300 requesting access to the protected file. The file protection system 210, or a corresponding device security system, monitors for security-based communications on the client device 300 at a system-wide level and intercepts the file access request. In some implementations, the client application 204 provides the file access request directly to the file protection system 210 or the corresponding device security system.

Act 504 includes the file protection system 210 using the security information metadata to determine whether the user is authorized to access the protected file. For example, in response to identifying the file access request, the file protection system 210 extracts and/or parses the security information metadata from the protected file. The security information metadata often includes unencrypted information that allows the file protection system 210 to recognize the access rights and permissions for a protected file even if the content is encrypted.

In various implementations, the file protection system 210 determines whether a user is authorized by comparing information in the file access request to the access rights and permissions in the security information metadata. For example, the file protection system 210 identifies the user identifier in the security information metadata and a corresponding set of allowed rights. For instance, the user identifier indicates that the user is a full-time employee in a given role, and the security information metadata confirms that all full-time employees in that role have authorization to access the protected file.

In various implementations, the security information metadata can include security protection information that indicates the sensitivity level and access controls of the protected file. Using the security information metadata, the file protection system 210 can determine whether the requesting user has an authorized role or clearance level, and if so, what levels of access to permit.

In some implementations, the file protection system 210 communicates with a remote source (e.g., a cloud protection system) to determine whether to grant the file access request. For example, the file protection system 210 provides a user identifier associated with the requesting application and security information from the security information metadata (e.g., DLP data) to a remote rights management service. The cloud protection system may return privileges for the user identifier, which the file protection system 210 uses to determine whether to grant access. In some instances, the cloud protection system returns a decision regarding whether to grant access to the protected file.

As shown in FIG. 5, act 506 includes denying the request. In particular, if the file protection system 210 determines that the client application 204 and/or associated user is not authorized to access the protected file, the file protection system 210 denies the file access request. In some implementations, the file protection system 210 provides a signal or indication to the client application 204 regarding the denial and/or when authorization was not granted.

Based on the determination that the user is authorized, the file protection system 210 decrypts the encrypted content in the protected file, if needed, as shown in act 508. For example, if the protected file is the protected encrypted file 501 with encrypted content, the file protection system 210 uses the security information metadata to decrypt the content, converting the protected encrypted file into a protected unencrypted file. In various implementations, the file protection system 210 uses the security information metadata to determine which encryption keys to apply and/or where to locate an encryption key (e.g., locally or remotely). If the protected file is a protected unencrypted file 503, the file protection system 210 may skip or omit the act 508.

Act 510 includes the file protection system 210 identifying permitted access rights to the file using the security information metadata. For example, the file protection system 210 determines which access rights and permissions to grant to the client application 204 based on the security protection information included in the security information metadata. In some instances, act 510 may be performed in combination with act 506.

In various implementations, the file protection system 210 utilizes the security information metadata to determine what level of access to permit. While current systems remove all restrictions upon encrypting content, the file protection system 210 may still enforce a range of access rights based on the security information metadata, which continues to be bound to the protected file. Indeed, the security information metadata may indicate to the file protection system 210 whether to grant full or partial access rights (e.g., read-only rights, execution rights, duplication rights, and others). While allowing the client application 204 to access the file content, the file protection system 210 may enforce a range of restrictions in adherence to security policies supported in the security information metadata.

To illustrate, act 512 shows the file protection system 210 enabling the client application 204 with limited access rights to the protected file. Act 514 shows the file protection system 210 enabling the client application 204 with full access rights to the protected file. The file protection system 210 may indicate the level of granted rights to the client application 204, allowing the user to interact with the content of the protected file according to those rights.

In one or more implementations, the file protection system 210 allows a user to copy a protected file if permitted by the access rights and permissions included in the file's security information metadata. In these implementations, the file protection system 210 may copy the security information metadata from the parent protected file to the child protected file. In many instances, the child protected file inherits the security information metadata of the parent protected file. In some implementations, the child protected file is assigned stricter access rights or permissions than the parent protected file (e.g., further duplicates cannot be made, or the child is view-only).

In some implementations, when the access rights include editing permissions, the client application 204 may make changes to the content without modifying the security information metadata of the protected file. By doing so, the file protection system 210 can continue to accurately enforce the originally intended access rights and permissions on the client device 300 as different applications (or the same application at different times) request access, even as the content of the protected file changes.

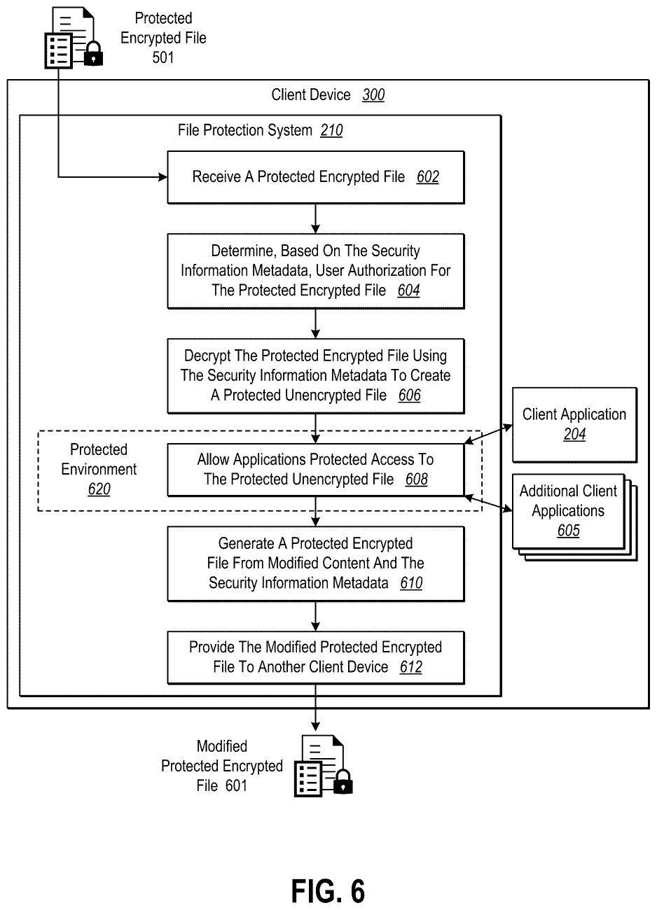

FIG. 6 expands on the concept of a client efficiently accessing the content of a protected file. Specifically, FIG. 6 provides additional details about the file protection system 210 providing a protected environment on a client device that significantly improves efficiency by eliminating the need for the client device to decrypt and re-encrypt the file each time the protected file is accessed. In particular, FIG. 6 illustrates an example block diagram of using security information metadata to access the content of a protected encrypted file and re-protecting the content in a modified protected encrypted file that retains the same access rights and permissions according to some implementations.

As shown, FIG. 6 includes the client device 300 with the file protection system 210 introduced earlier. The file protection system 210 on the client device 300 receives a protected encrypted file 501. The client device 300 includes the client application 204 and additional client applications 605.

In various implementations, the file protection system 210 creates or establishes a protected environment on the client device 300. In some cases, the protected environment includes all user files stored on the client device 300. In various cases, the protected environment is limited to a specific file directory, such as files associated with a particular user of the client device 300, files within a designated drive, or files within a specific project directory.

In these implementations, the purpose of the protected environment is to store protected files as protected unencrypted files within the environment, thus eliminating the need for decrypting and re-encrypting each time a file access request is made for the protected file. Instead, protected encrypted files are decrypted when entering the protected environment and re-encrypted when exiting the environment. By doing so, the file protection system 210 significantly reduces the computational requirements needed to unprotect and re-protect files while within the protected environment, all while maintaining access protection through the security information metadata bound to the file.

To illustrate, FIG. 6 includes a series of acts performed by the file protection system 210, including act 602 of receiving a protected encrypted file. As described above, the client device 300 may receive the protected encrypted file 501 through a variety of ways.

Act 604 includes determining, based on the security information metadata, user authorization for the protected encrypted file. As described above, the file protection system 210 determines whether the user identifier associated with the client device 300 has the access rights and permissions for the protected encrypted file 501. For example, the file protection system 210 determines that the user of the client device 300 has either full or limited permissions when accessing the protected encrypted file 501.

Act 606 includes the file protection system 210 decrypting the protected encrypted file using the security information metadata to create a protected unencrypted file. As described above, the file protection system 210 uses the security information metadata bound to the unencrypted content of the protected encrypted file 501 to decrypt the content and create a protected unencrypted file on the client device 300. The file protection system 210 keeps or retains the security information metadata bound to the unencrypted content within the protected unencrypted file.

In creating the protected unencrypted file from the protected encrypted file, the file protection system 210 may store the protected unencrypted file in a protected environment 620. The protected environment 620 may include some or all of the file locations or directories on the client device 300. The protected environment 620 may include multiple protected unencrypted files to which the user is authorized to access. Regardless of where the protected environment 620 is located on the client device 300, the file protection system 210 provides system-wide monitoring and responsiveness to access requests associated with protected files.

While a protected unencrypted file is in the protected environment 620, applications on the client device 300 may have open access to the unencrypted content, according to the access rights and permissions indicated in the file's security information metadata. To illustrate, act 608 includes the file protection system 210 allowing applications protected access to the protected unencrypted file within the protected environment 620.

To further elaborate, the file protection system 210 provides client applications with full or limited access to the content of the protected unencrypted file while in the protected environment 620. For example, the client application 204 accesses and modifies the unencrypted content of the protected unencrypted file. In addition, the additional client applications 605 can also access the unencrypted file to view and/or modify the content (if authorized). While in the protected environment 620, the content remains unencrypted. The applications can similarly access other protected unencrypted files within the protected environment 620.

Act 610 includes the file protection system 210 generating a protected encrypted file from modified content and the security information metadata. For example, in preparation to move protected unencrypted files from the protected environment 620, the file protection system 210 regenerates a protected encrypted file for the content. In this example, the file protection system 210 generates a modified protected encrypted file 601 from content modified while within the protected environment 620.

As described above, the file protection system 210 may use the security information metadata bound to the modified unencrypted content to encrypt the modified content into the modified protected encrypted file 601. By doing so, the file protection system 210 preserves the original security protections of the protected file while flexibly allowing the content of the protected file to be changed by authorized users (if content modification was included in the original protection intent).

Act 612 includes providing the modified protected encrypted file 601 to another client device. For example, the client device 300 provides the modified protected encrypted file 601 to another device. As described further in connection with FIG. 7 below, while the modified protected encrypted file 601 is provided to another client device, the security information metadata ensures only authorized access to the file's protected content.

FIG. 7 illustrates an example sequence diagram for providing a protected encrypted file across client devices while maintaining the originally implemented access rights and permissions according to some implementations. FIG. 7 corresponds to maintaining security protections for a protected file, even when the file is provided or egressed to other devices.

As shown, FIG. 7 includes the first client device 202, the second client device 240, and the third client device 250, which were introduced above. In addition, FIG. 7 includes a series of acts 700 performed in connection with the file protection system.

To illustrate, the series of acts 700 includes act 702 generating, at the first client device 202, a protected encrypted file including content and security information metadata enforcing a first set of access rights and permissions. For example, an instance of the file protection system 210 at the first client device 202 creates a protected encrypted file with encrypted content and corresponding security information metadata. As mentioned, the protected encrypted file is protected or secured according to a first set of access rights and permissions, which may be included in the security information metadata bound to the file. For instance, the first set of access rights and permissions corresponds to the original security intent for the content, which should be preserved and enforced until removed by the original enforcing user or system.

Act 704 includes the first client device 202 providing the protected encrypted file to the second client device 240. For example, the first client device 202 egresses the protected encrypted file to the second client device 240 via network communications, removable storage, network sharing, uploading/downloading, or cloud storage sharing. In response, the second client device 240 receives the protected encrypted file. Because the file content is encrypted, the file protection system 210 can safely transfer the protected encrypted file between client devices.

The second client device 240 may include an instance of the file protection system 210 that processes the protected encrypted file. As shown, act 706 includes determining that the second client device 240 has limited access to the file based on the first set of access rights and permissions in the security information metadata. For example, the file protection system 210 ensures that egress permissions are allowed for the protected encrypted file. In addition, the file protection system 210 can compare a user identifier from the second client device 240 against the security information metadata to determine that the second client device 240 has limited access rights.

Based on the second client device 240 being authorized with limited rights for the protected encrypted file, the file protection system 210 decrypts the encrypted content from the protected encrypted file, as shown in act 708. As described above, the file protection system 210 can use the security information metadata to decrypt the encrypted content. In various implementations, the file protection system 210 generates a protected unencrypted file on the second client device 240.

Act 710 includes allowing applications to make edits to the content. Because the second client device 240 is authorized with limited access, applications on the second client device 240 may only be granted the same limited access. In some implementations, the second client device 240 operates in a protected environment 620 that allows content to be internally stored as a protected unencrypted file. In various implementations, an application on the second client device 240 modifies the content, as described above.

Act 712 includes the second client device 240 encrypting the modified content using the first set of access rights and permissions in the security information metadata. For example, the file protection system 210 on the second client device 240 uses the first set of access rights and permissions from the security information metadata to encrypt the modified content according to the original security intent.

Act 714 includes the second client device 240 providing the modified protected encrypted file to the third client device 250. For example, the second client device 240 egresses the protected encrypted file to the third client device 250 via network communication. In response, the third client device 250 receives the protected encrypted file.

Act 716 includes determining that the third client device does not have access to the file based on the first set of access rights and permissions in the security information metadata. For example, a third user associated with the third client device 250 is not permitted to access the protected file according to the original security intent. Accordingly, even as the protected encrypted file is sent to different client devices, only those devices authorized by the original security intent in the security information metadata are allowed limited or full access. Furthermore, as described above, the file protection system 210 also permits authorized users to make approved changes to the content of the protected file while still preserving the original security intent as the protected file is shared among devices.

While FIG. 7 shows only three client devices, any number of client devices can include instances of the file protection system 210. These devices may receive the protected encrypted file, and those devices associated with authorized users or systems will be allowed or granted access. Otherwise, the file protection system on the client device will deny the unauthorized access.

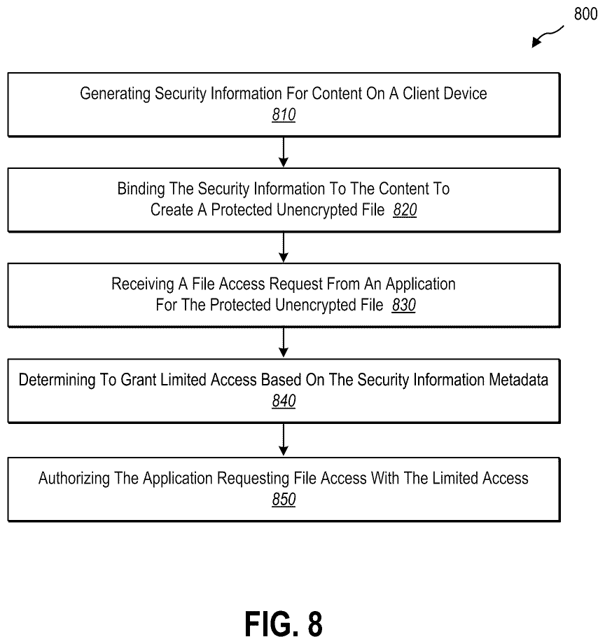

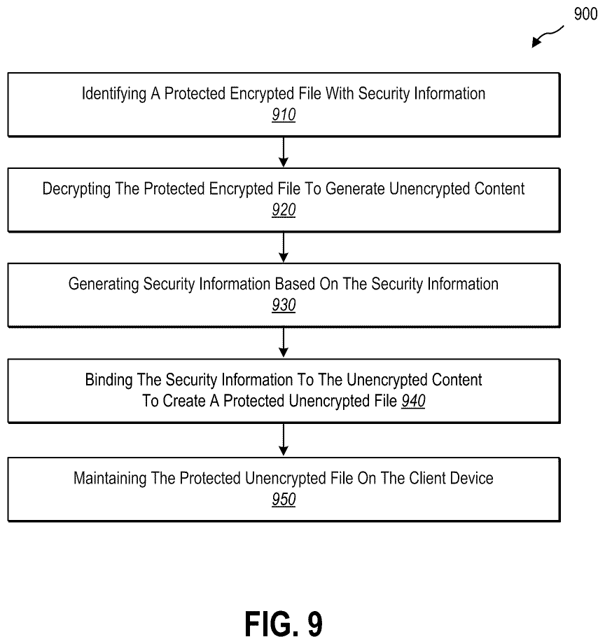

Turning now to FIGS. 8-9, which each illustrates an example series of acts in a computer-implemented method for providing system-wide endpoint file protection on a computing device according to some implementations. While FIGS. 8-9 illustrate acts according to one or more implementations, alternative implementations may omit, add, reorder, and/or modify any of the acts shown.

The acts in FIGS. 8-9 can be performed as part of a method (e.g., a computer-implemented method). Alternatively, a computer-readable medium can include instructions that, when executed by a processing system with a processor, cause a computing device to perform the acts in FIGS. 8-9. In some implementations, a system (e.g., a processing system comprising a processor) can perform the acts in FIGS. 8-9. For example, the system includes a processing system and a computer memory including instructions that, when executed by the processing system, cause the system to perform various actions, operations, or steps.

To illustrate, in FIG. 8, the series of acts 800 includes act 810 of generating security information for content on a client device. For instance, in example implementations, act 810 involves generating, on a client device, security information metadata for unencrypted content. In various implementations, act 810 includes receiving a protected encrypted file that includes an encrypted portion and a security information portion. In some instances, act 810 includes decrypting the encrypted portion of the protected encrypted file to generate the unencrypted content using a data decryptor. In various instances, generating the security information metadata occurs at a system-wide level, and/or generating the security information metadata is application-agnostic.

As further shown, the series of acts 800 includes act 820 of binding the security information to the content to create a protected unencrypted file. For instance, in example implementations, act 820 involves binding the security information metadata to the unencrypted content to create a protected unencrypted file on the client device. In one or more implementations, act 820 includes, in response to receiving an additional protected unencrypted file from an external client device, generating an additional protected unencrypted file having additional unencrypted content that is bound with additional security information metadata. In various implementations, the additional unencrypted content remains unencrypted while located on the client device. In some implementations, binding the security information metadata occurs at the system-wide level, and/or binding the security information metadata is application-agnostic. In various implementations, the security information metadata includes system-level information that is hidden from the user interface of the client device.

As further shown, the series of acts 800 includes act 830 of receiving a file access request from an application for the protected unencrypted file. For instance, in some implementations, act 830 involves receiving a file access request on the client device from an application seeking or requesting access to the protected unencrypted file. In various instances, act 830 includes receiving the file access request by intercepting a communication to access the protected unencrypted file between the application and the operating system of the client device.

Furthermore, the series of acts 800 includes act 840 of determining to grant limited access based on the security information metadata. For instance, in example implementations, act 840 involves determining, based on the security information metadata of the protected unencrypted file, to grant limited access to the unencrypted content of the protected unencrypted file. In various implementations, act 840 includes determining to grant limited access to the unencrypted content of the protected unencrypted file by receiving, in the file access request, a user identifier associated with the file access request, determining that the security information metadata includes the user identifier associated with the limited access, and enforcing the application to adhere to the limited access with respect to the unencrypted content.

As further shown, the series of acts 800 includes act 850 of authorizing the application requesting file access with the limited access. For instance, in example implementations, act 850 involves authorizing the application requesting file access with the limited access to the unencrypted content based on determining to grant the limited access to the unencrypted content. In one or more implementations, act 850 includes identifying the application creating modified unencrypted content from the unencrypted content, generating a modified protected encrypted file by encrypting the modified unencrypted content using the security information metadata, and providing the modified protected encrypted file to an external client device

The series of acts 800 can include additional acts. For example, in one or more implementations, the series of acts 800 includes receiving a share request to provide the additional protected unencrypted file to an external computing device, encoding the additional unencrypted content according to the additional security information metadata to create additional encrypted content in response to receiving the share request, associating the additional security information metadata with the additional encrypted content to create an additional protected encrypted file in response to receiving the share request, and providing the additional protected encrypted file to the external client device in response to the share request.

In various implementations, the series of acts 800 includes blocking application access to an additional protected unencrypted file with additional unencrypted content on the client device based on determining that a user identifier associated with an additional file access request is not included in the additional security information metadata bound to the additional protected unencrypted content within the additional protected unencrypted file

Turning to FIG. 9 and the series of acts 900, as shown, the series of acts 900 includes act 910 of identifying a protected encrypted file with security information. For instance, in example implementations, act 910 involves identifying an encrypted portion and a security information portion from a protected encrypted file. In various implementations, act 910 includes receiving a protected encrypted file that includes an encrypted portion and a security information portion. In some instances, act 910 includes decrypting the content (e.g., the encrypted content) from the encrypted portion of the protected encrypted file using a data decryptor to generate the unencrypted content. In one or more implementations, act 910 includes generating the security information metadata by copying the security information portion to the security information metadata.

As further shown, the series of acts 900 includes act 920 of decrypting the protected encrypted file to generate unencrypted content. For instance, in example implementations, act 920 involves decrypting the encrypted portion of the protected encrypted file to create, produce, or generate unencrypted content. In one or more implementations, act 920 includes binding the security information metadata to the unencrypted content to create the protected unencrypted file on the client device. In some instances, the protected encrypted file corresponds to file protections associated with a first identifier. In some cases, the security information metadata preserves the file protections associated with the first identifier. In one or more cases, a subsequent re-encryption of the unencrypted content is based on the file protections associated with the first identifier. In various implementations, the security information metadata includes user identifier access information, access type restrictions, and information sensitivity levels. In some instances, the limited access includes viewing rights, editing rights, macro execution rights, copying rights, naming rights, sharing rights, exporting rights, commenting rights, or printing rights.

As further shown, the series of acts 900 includes act 930 of generating security information based on the security information. For instance, in some implementations, act 930 involves generating security information metadata based on the security information portion. In some implementations, act 930 includes receiving the protected encrypted file with the encrypted portion and the security information portion from an external client device. In various implementations, act 930 includes receiving a file access request on the client device from an application requesting access to the protected unencrypted file.

Furthermore, the series of acts 900 includes act 940 of binding the security information to the unencrypted content to create a protected unencrypted file. For instance, in example implementations, act 940 involves binding the security information metadata to the unencrypted content to create a protected unencrypted file on the client device. In various implementations, act 940 includes decrypting the encrypted portion of the protected encrypted file using a data decryptor. In one or more implementations, act 940 includes determining, based on the security information metadata of the protected unencrypted file, to grant limited access to the unencrypted content of the protected unencrypted file.

As further shown, the series of acts 900 includes act 950 of maintaining the protected unencrypted file on the client device. For instance, in example implementations, act 950 involves maintaining the protected unencrypted file on the client device for authorized access by one or more applications on the client device. In one or more implementations, act 950 includes authorizing the application requesting file access with limited access to the unencrypted content based on determining to grant the limited access to the unencrypted content. In various instances, multiple applications on the client device access the unencrypted content according to the limited access indicated by the security information metadata bound to the encrypted content.

The series of acts 900 can include additional acts. For example, in one or more implementations, the series of acts 900 includes receiving an additional protected encrypted file from an external device, creating an additional protected unencrypted file from the additional protected encrypted file, authorizing limited access to the additional unencrypted content of the additional protected unencrypted file based on the additional security information metadata bound to the additional unencrypted content being met, and re-encrypting the additional protected unencrypted file with the additional security information metadata. In some instances, the additional protected unencrypted file includes additional unencrypted content and additional security information. In one or more implementations, the security information metadata is enforced across multiple applications on the client device accessing the unencrypted content.

FIG. 10 illustrates certain components that may be included within a computer system 1000. The computer system 1000 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 1000 represents one or more of the client devices, server devices, or other computing devices described above. For example, the computer system 1000 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 1000 includes a processing system including a processor 1001. The processor 1001 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 1001 may be referred to as a central processing unit (CPU) and may cause computer-implemented instructions to be performed. Although the processor 1001 shown is just a single processor in the computer system 1000 of FIG. 10, in an alternative configuration, a combination of processors (e.g., an ARM and DSP) could be used.

The computer system 1000 also includes memory 1003 in electronic communication with the processor 1001. The memory 1003 may be any electronic component capable of storing electronic information. For example, the memory 1003 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 1005 and the data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during the execution of the instructions 1005 by the processor 1001.

A computer system 1000 may also include one or more communication interface(s) 1009 for communicating with other electronic devices. The one or more communication interface(s) 1009 may be based on wired communication technology, wireless communication technology, or both. Some examples of the one or more communication interface(s) 1009 include a Universal Serial Bus (USB), an Ethernet adapter, a wireless adapter that operates according to an Institute of Electrical and Electronics Engineers (IEEE) 1002.11 wireless communication protocol, a Bluetooth® wireless communication adapter, and an infrared (IR) communication port.

A computer system 1000 may also include one or more input device(s) 1011 and one or more output device(s) 1013. Some examples of the one or more input device(s) 1011 include a keyboard, mouse, microphone, remote control device, button, joystick, trackball, touchpad, and light pen. Some examples of the one or more output device(s) 1013 include a speaker and a printer. A specific type of output device that is typically included in a computer system 1000 is a display device 1015. The display device 1015 used with implementations disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For clarity, the various buses are illustrated in FIG. 10 as a bus system 1019.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that fall within the meaning and range of equivalency of the claims are to be embraced within their scope.

What is claimed is:

1. A computer-implemented method for providing system-wide endpoint file protection on a computing device, comprising:
generating, on a client device, security information metadata for unencrypted content;
binding the security information metadata to the unencrypted content to create a protected unencrypted file on the client device;
receiving a file access request on the client device from an application requesting access to the protected unencrypted file;
determining, based on the security information metadata, to grant limited access to the unencrypted content; and
authorizing the application requesting file access with the limited access to the unencrypted content based on determining to grant the limited access to the unencrypted content.

2. The computer-implemented method of claim 1, further comprising:
receiving a protected encrypted file that includes an encrypted portion and a security information portion; and
decrypting the encrypted portion to generate the unencrypted content using a data decryptor.

3. The computer-implemented method of claim 2, further comprising:
identifying the application creating modified unencrypted content from the unencrypted content;
generating a modified protected encrypted file by encrypting the modified unencrypted content using the security information metadata; and
providing the modified protected encrypted file to an external client device.

4. The computer-implemented method of claim 3, wherein determining to grant limited access to the unencrypted content includes:
receiving, in the file access request, a user identifier associated with the file access request;
determining that the security information metadata includes the user identifier associated with the limited access; and
enforcing the application to adhere to the limited access with respect to the unencrypted content.

5. The computer-implemented method of claim 1, wherein:
generating the security information metadata occurs at a system-wide level;
generating the security information metadata is application-agnostic;
binding the security information metadata occurs at the system-wide level; and
binding the security information metadata is application-agnostic.

6. The computer-implemented method of claim 1, further comprising, in response to receiving an additional protected unencrypted file from an external client device, generating an additional protected unencrypted file having an additional unencrypted content that is bound with an additional security information metadata, wherein the additional unencrypted content remains unencrypted while located on the client device.

7. The computer-implemented method of claim 6, further comprising:
receiving a share request to provide the additional protected unencrypted file to an external computing device;
in response to receiving the share request, encoding the additional unencrypted content according to the additional security information metadata to create additional encrypted content;
associating the additional security information metadata with the additional encrypted content to create an additional protected encrypted file; and
providing the additional protected encrypted file to the external client device in response to the share request.

8. The computer-implemented method of claim 1, further comprising blocking application access to an additional protected unencrypted file with additional unencrypted content on the client device based on determining that a user identifier associated with an additional file access request is not included in an additional security information metadata bound to additional protected unencrypted content within the additional protected unencrypted file.

9. The computer-implemented method of claim 1, wherein the security information metadata includes system-level information hidden from a user interface of the client device.

10. The computer-implemented method of claim 1, wherein receiving the file access request includes intercepting a communication to access the protected unencrypted file between the application and an operating system of the client device.

11. A system comprising:
a client device having a processor; and
a computer memory including instructions that, when executed by the client device, cause the client device to carry out operations comprising:
identifying an encrypted portion and a security information portion from a protected encrypted file;
decrypting the encrypted portion of the protected encrypted file to generate unencrypted content;
generating security information metadata based on the security information portion;
binding the security information metadata to the unencrypted content to create a protected unencrypted file on the client device; and
maintaining the protected unencrypted file on the client device for authorized access by one or more applications on the client device.

12. The system of claim 11, further comprising:
receiving the protected encrypted file with the encrypted portion and the security information portion from an external client device; and
decrypting the encrypted portion using a data decryptor.

13. The system of claim 11, further comprising:
receiving a file access request on the client device from an application requesting access to the protected unencrypted file;
determining, based on the security information metadata, to grant limited access to the unencrypted content; and
authorizing the application requesting file access with the limited access to the unencrypted content based on determining to grant the limited access to the unencrypted content.

14. The system of claim 13, wherein the security information metadata is enforced across multiple applications on the client device accessing the unencrypted content.

15. The system of claim 13, further comprising:
receiving an additional protected encrypted file from an external device;
creating an additional protected unencrypted file from the additional protected encrypted file, wherein the additional protected unencrypted file includes additional unencrypted content and additional security information;
authorizing limited access to the additional unencrypted content based on additional security information metadata bound to the additional unencrypted content being met; and
re-encrypting the additional protected unencrypted file with the additional security information metadata.

16. A non-transitory computer-readable storage medium comprising instructions that, when executed by a processor, cause a computer device to carry out operations comprising:
maintaining, on a client device, a protected unencrypted file having security information metadata bound to unencrypted content;
receiving a file access request on the client device from an application requesting access to the protected unencrypted file;
determining, based on the security information metadata, to grant limited access to the unencrypted content; and
authorizing the application requesting file access with the limited access to the unencrypted content based on determining to grant the limited access to the unencrypted content.

17. The non-transitory computer-readable storage medium of claim 16, further comprising:
receiving a protected encrypted file that includes an encrypted portion and a security information portion;
decrypting encrypted content from the encrypted portion using a data decryptor to generate the unencrypted content;
generating the security information metadata based on copying the security information portion to the security information metadata; and
binding the security information metadata to the unencrypted content to create the protected unencrypted file on the client device.

18. The non-transitory computer-readable storage medium of claim 17, wherein:
the protected encrypted file corresponds to file protections associated with a first identifier;
the security information metadata preserves the file protections associated with the first identifier; and
a subsequent re-encryption of the unencrypted content is based on the file protections associated with the first identifier.

19. The non-transitory computer-readable storage medium of claim 17, wherein multiple applications on the client device access the unencrypted content according to the limited access indicated by the security information metadata bound to the unencrypted content.

20. The non-transitory computer-readable storage medium of claim 16, wherein:
the security information metadata includes user identifier access information, access type restrictions, and information sensitivity levels; and
the limited access includes viewing rights, editing rights, copying rights, or printing rights.
